(19) United States
(12) Patent Application Publication
(10) Pub. No.: US 2013/0131959 A1
(43) Pub. Date: May 23, 2013

(54) STARTING CONTROL DEVICE AND STARTING CONTROL METHOD FOR INTERNAL COMBUSTION ENGINE

(71) Applicant: Toyota Jidosha Kabushiki Kaisha, Toyota-shi (JP)

(72) Inventors: Atsushi SHODA, Nagoya-shi (JP); Mitsuhiro NOMURA, Okazaki-shi (JP); Hiroya TANAKA, Miyoshi-shi (JP)

(73) Assignee: Toyota Jidosha Kabushiki Kaisha, Toyota-shi (JP)

(21) Appl. No.: 13/679,730

(22) Filed: Nov. 16, 2012

(30) Foreign Application Priority Data
Nov. 18, 2011 (JP) 2011-253094

(51) Int. Cl. F02D 41/00

(52) U.S. Cl. CPC F02D 41/0002
USPC 701/103

(57) ABSTRACT

When a fuel oil leakage from an injector during a stop of an engine is large and a fuel oil leakage determination condition is satisfied, an intake air flow rate is increased and then the engine is started. Through such control, while the engine is cranked at the time of a start, it is possible to early scavenge an air-fuel mixture having a high concentration of HC, and it is possible to optimize an air-fuel ratio (set an air-fuel ratio to an appropriate value within a combustible range) at the time of a start of the engine. As a result, a combustion state gets better, torque at the time of a start of the engine increases, and the startability of the engine improves.

INCORPORATION BY REFERENCE

The disclosure of Japanese Patent Application No. 2011-253094 filed on Nov. 18, 2011 including the specification, drawings and abstract is incorporated herein by reference in its entirety.

### BACKGROUND OF THE INVENTION

1. Field of the Invention

The invention relates to a starting control device and starting control method for an internal combustion engine that is mounted on a vehicle, or the like.

2. Description of Related Art

An internal combustion engine (hereinafter, also referred to as engine) mounted on a vehicle, or the like, for example, introduces an air-fuel mixture of air flowing through an intake passage and fuel injected from a fuel injection valve (hereinafter, also referred to as injector) into a combustion chamber, ignites the air-fuel mixture with an ignition plug to cause the air-fuel mixture to combust and explode, and rotates a crankshaft by energy (power) generated through the combustion and explosion of the air-fuel mixture. Such an engine is started by cranking the engine with a starter (motor) coupled to the crankshaft and supplying and igniting fuel in synchronization with the cranking.

Then, in an engine that supplies fuel with an injector, it is known that a so-called fuel oil leakage may occur (for example, see Japanese Patent Application Publication No. 2008-025521 (JP 2008-025521 A)). The fuel oil leakage is a leakage of fuel from the injector during a stop of the engine (during soaking).

Incidentally, a fuel oil leakage from the injector varies depending on an operating condition and an environmental condition at the time when the engine is stopped. For example, when the fuel temperature and the fuel pressure are high at the time of an engine stop in a low-speed high-load driving state, an uphill travelling state, or the like, or when an outside air temperature is high in summer, or the like, and the fuel temperature and the fuel pressure are high, a fuel oil leakage from the injector increases. As a fuel oil leakage from the injector increases, the concentration of HC (hydrocarbons) in an intake manifold (intake port) increases. Then, when the air-fuel ratio of air-fuel mixture becomes rich and exceeds the range of combustible air-fuel ratio due to the high HC concentration, a combustion state may deteriorate, causing a failure to start the engine.

### SUMMARY OF THE INVENTION

The invention implements starting control by which it is possible to ensure appropriate startability in an internal combustion engine mounted on a vehicle, or the like.

A first aspect of the invention relates to a starting control device for an internal combustion engine that causes an air-fuel mixture of intake air and fuel injected from a fuel injection valve to combust in a combustion chamber to obtain power. The starting control device includes a control unit configure to execute scavenging control at the time of a start of the engine when a condition for determining a fuel oil leakage from the fuel injection valve is satisfied. More specifically, the scavenging control may be control for increasing an intake air flow rate at the time of a start of the engine.

According to the above aspect, when a fuel oil leakage from the fuel injection valve during an engine stop is large and the condition for determining a fuel oil leakage is satisfied, the internal combustion engine is started while the scavenging control (intake air flow rate increasing control) is executed, so it is possible to early scavenge an air-fuel mixture having a high concentration of HC while the internal combustion engine is cranking at the time of a start of the engine. By so doing, it is possible to optimize the air-fuel ratio at the time of a start of the engine (set the air-fuel ratio to an appropriate value within a combustible range), so a combustion state gets better and the engine rotation speed quickly increases. As a result, a torque at the time of a start of the engine increases, and the startability of the internal combustion engine improves.

In the above aspect, the control unit may increase the intake air flow rate by controlling an opening degree of a throttle valve, provided in an intake passage that communicates with the combustion chamber, at the time of a start of the engine (opening control). In this case, the control unit may control the opening degree of the throttle valve at the time of increasing the intake air flow rate (during scavenging control) to an opening degree at which negative pressure is not generated in the intake passage downstream of the throttle valve in a flow of the intake air and the amount of fresh air is maximum (scavenging effect is maximum). By setting the opening degree such that negative pressure is not generated in the intake passage in this way, it is possible to improve the scavenging effect at the time of a start of the engine (cranking), so it is possible to obtain further appropriate startability.

In the above aspect, the control unit may set the opening degree of the throttle valve in the case of increasing the intake air flow rate (during scavenging control) on the basis of an engine coolant temperature and an engine rotation speed. With this configuration, it is possible to appropriately set the amount of increase in the intake air flow rate at the time of a start of the engine on the basis of a condition at the time of the start of the engine, so it is possible to obtain a stable scavenging effect.

In the above aspect, in consideration of the fact that negative pressure in the intake passage (intake manifold negative pressure) increases with an increase in cranking rotation speed at the time of a start of the engine, the control unit may increase the opening degree of the throttle valve with an increase in cranking rotation speed at the time of a start of the engine to gradually increase (or increase in a stepwise manner) the intake air flow rate such that negative pressure is not generated in the intake passage.

In the above aspect, the control unit may end the control for increasing the intake air flow rate (throttle valve opening control) at the time of a start of the engine when an engine rotation speed becomes higher than or equal to a predetermined value (for example, a rotation speed at which it is possible to sufficiently scavenge an air-fuel mixture having a high concentration of HC). Alternatively, the control unit may end the control for increasing the intake air flow rate (throttle valve opening control) at the time of a start of the engine when a rate of increase in the engine rotation speed becomes higher than or equal to a predetermined value (for example, a rate of increase in the rotation speed at which it is possible to sufficiently scavenge an air-fuel mixture having a high concentration of HC). Alternatively, the control unit may end the control for increasing the intake air flow rate at the time of a start of the engine when an engine rotation speed becomes higher than or equal to a predetermined value and when a rate of increase in the engine rotation speed becomes higher than or equal to a predetermined value.

In addition, the control unit may end the control for increasing the intake air flow rate (throttle valve opening control) at the time of a start of the engine when the number of revolutions of the internal combustion engine is larger than or equal to a predetermined value. In this case, for example, a count value is counted up by one each time the engine (crankshaft) rotates 360° and, when the count value is larger than or equal to a predetermined value (for example, a count value (the number of revolutions of the engine) at which it is possible to sufficiently scavenge an air-fuel mixture having a high concentration of HC), control for increasing the intake air flow rate (throttle valve opening control) is ended.

In the above aspect, when the control unit ends the control for increasing the intake air flow rate (throttle valve opening control) at the time of a start of the engine, the control unit may execute ignition timing retardation control when a rate of increase in the engine rotation speed is higher than or equal to the predetermined value (for example, the same value as the determination value (rotation speed increase rate determination value) for determining an end of the scavenging control). By executing such retardation control, it is possible to prevent a steep increase in engine rotation speed due to an increase in the intake air flow rate.

In the above aspect, the condition for determining a fuel oil leakage from the fuel injection valve may be, for example, a condition that a difference between a coolant temperature at the time of a last engine stop and a coolant temperature at the time of a restart of the engine is larger than or equal to a predetermined value and an intake air temperature at the time of the restart is lower than or equal to a predetermined value. In addition, in addition to such a condition for determining a fuel oil leakage from the fuel injection valve, a condition that a decrease in the coolant temperature at the restart of the engine with respect to the coolant temperature at the last engine stop ([Coolant temperature at the time of the last stop]−[Coolant temperature at the time of the restart]) is larger than or equal to a coolant temperature decrease determination value set for each coolant temperature at the time of a last stop may be set.

Note that, another determination condition may be set as the condition for determining a fuel oil leakage from the fuel injection valve as long as it is possible to determine combustion deterioration (engine start failure) at the time of a restart due to a fuel oil leakage from the fuel injection valve during an engine stop.

A second aspect of the invention relates to a starting control method for an internal combustion engine that causes an air-fuel mixture of intake air and fuel injected from a fuel injection valve to combust in a combustion chamber to obtain power. The starting control method includes executing scavenging control at the time of a start of the engine when a condition for determining a fuel oil leakage from the fuel injection valve is satisfied.

According to the aspects of the invention, when a fuel oil leakage from the fuel injection valve during an engine stop is large and a fuel oil leakage determination condition is satisfied, scavenging control is executed at the time of a start of the engine, so it is possible to early scavenge an air-fuel mixture having a high concentration of HC. By so doing, it is possible to ensure further appropriate startability.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view that shows the configuration of the engine to which the invention is applied;

FIG. 2 is a diagram of the configuration of the engine control system shown in FIG. 1;

FIG. 3 is an example of a flowchart of the engine starting control executed by the ECU;

FIG. 4 is an example of a timing chart of the engine starting control;

FIG. 5 is an example of a map to obtain a cooling temperature determination value;

FIG. 6 is an example of a map to obtain a throttle opening degree at the time of an engine start:

FIG. 7 is another example of a flowchart of the engine starting control executed by the ECU; and

FIG. 8 is another example of a timing chart of the engine starting control.

### DETAILED DESCRIPTION OF EMBODIMENTS

Hereinafter, an embodiment of the invention will be described with reference to the accompanying drawings.

First, an internal combustion engine (hereinafter, also referred to as engine) to which the invention is applied will be described.

### Engine

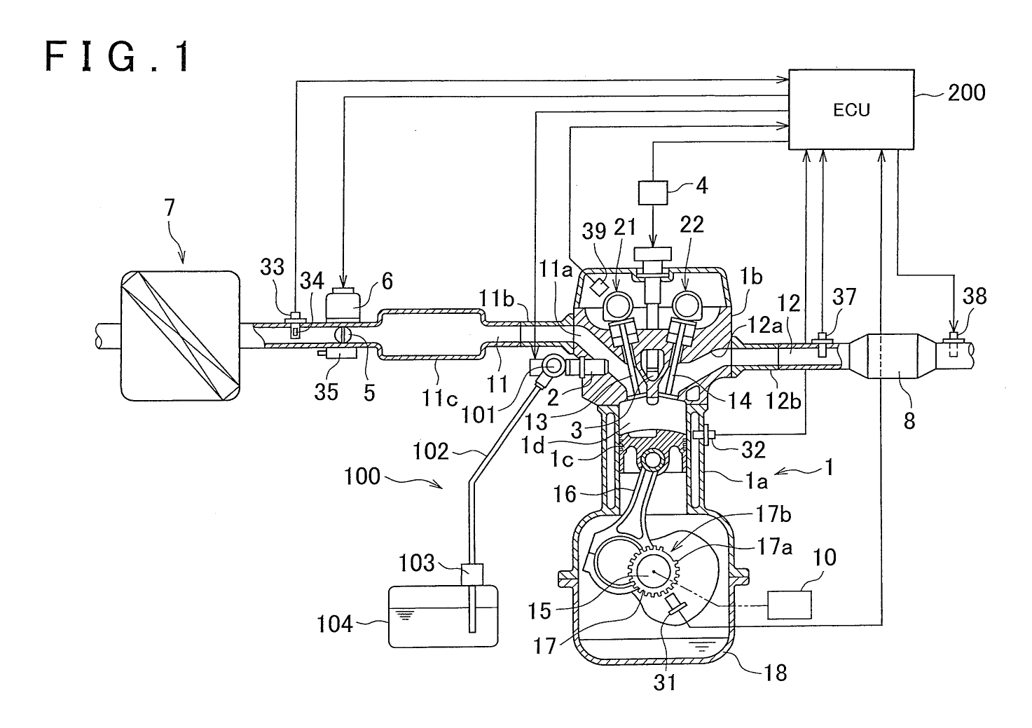

FIG. 1 is a view that shows the schematic configuration of the engine to which the invention is applied. Note that FIG. 1 shows the configuration of only one cylinder of the engine.

The engine 1 in this embodiment is a port-injection four-cylinder gasoline engine mounted on a vehicle. Pistons 1c that reciprocally move up and down are provided in a cylinder block 1a that constitute cylinders of the engine 1. The pistons 1c are coupled to a crankshaft 15 via corresponding connecting rods 16. The reciprocal motion of the pistons 1c is converted by the connecting rods 16 to the rotation of the crankshaft 15.

The crankshaft 15 of the engine 1 is coupled to a transmission (not shown) via a torque converter (or a clutch), and the like, and is able to transmit power from the engine 1 to drive wheels of the vehicle via the transmission.

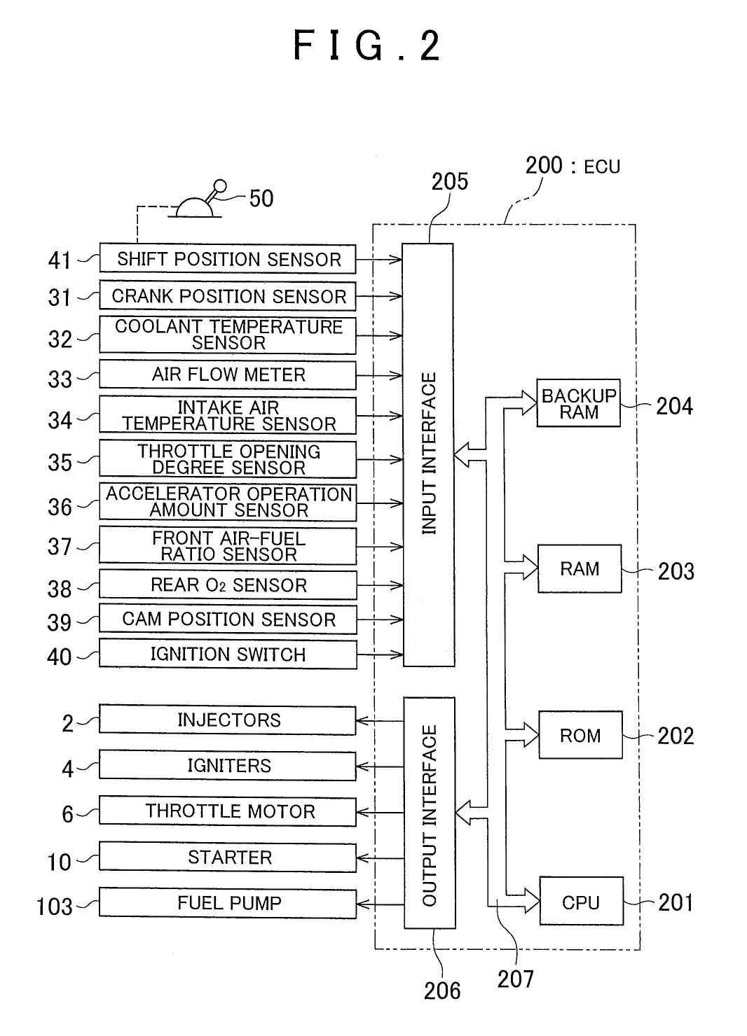

The transmission is, for example, a step-shift automatic transmission that sets a gear (for example, forward sixth-speed gear or reverse first-speed gear) with the use of frictional engagement elements, such as clutches and brakes, and a planetary gear mechanism. Ranges (parking range P, reverse range R, neutral range N and drive range D) of the transmission are changed by operating a shift lever 50 (see FIG. 2). The shift operating position (P, R, N or D range) of the shift lever 50 is detected by a shift position sensor 41. Note that the transmission may be a continuously variable transmission, such as a belt-type continuously variable transmission.

A starter (motor) 10 that is actuated at the time of starting the engine 1 is coupled to the crankshaft 15 of the engine 1. It is possible to crank the engine 1 by actuating the starter 10.

In addition, a signal rotor 17 is connected to the crankshaft 15. A plurality of teeth (protrusions) 17a are provided on the outer periphery of the signal rotor 17 at equal angular intervals (in this embodiment, for example, at intervals of 10° CA (crank angle)). In addition, the signal rotor 17 has a no-tooth portion at which the two teeth 17a are missing.

A crank position sensor 31 is arranged near the side of the signal rotor 17. The crank position sensor 31 detects a crank angle. The crank position sensor 31 is, for example, an electromagnetic pickup, and generates a pulse-shaped signal (voltage pulse) corresponding to the teeth 17a of the signal rotor 17 when the crankshaft 15 rotates. It is possible to calculate an engine rotation speed NE from the signal output from the crank position sensor 31.

A coolant temperature sensor 32 is arranged on the cylinder block 1a of the engine 1. The coolant temperature sensor 32 detects the temperature of engine coolant. In addition, a cylinder head 1b is provided on the upper end of the cylinder block 1a. Combustion chambers 1d are respectively formed between the cylinder head 1b and the pistons 1c. An ignition plug 3 is arranged in each of the combustion chambers 1d of the engine 1. The ignition timing of each ignition plug 3 is adjusted by an igniter 4. Each igniter 4 is controlled by an electronic control unit (ECU) 200.

An oil pan 18 is provided at the lower portion of the cylinder block 1a of the engine 1. The oil pan 18 stores lubricating oil (engine oil). Lubricating oil stored in the oil pan 18 is drawn by an oil pump (not shown) via an oil strainer, which removes foreign matter, during operation of the engine 1. The lubricating oil is then supplied to various portions of the engine, such as the pistons 1c, the crankshaft 15 and the connecting rods 16, and is used to, for example, lubricate and cool the various portions. Then, after the thus supplied lubricating oil is used to, for example, lubricate and cool the various portions of the engine, the lubricating oil is returned to the oil pan 18, and is stored in the oil pan 18 until the lubricating oil is drawn by the oil pump again.

An intake passage 11 and an exhaust passage 12 are connected to each of the combustion chambers 1d of the engine 1. Part of the intake passage 11 is formed of intake ports 11a and an intake manifold 11b. A surge tank 11c is provided in the intake passage 11. In addition, part of the exhaust passage 12 is formed of exhaust ports 12a and an exhaust manifold 12b.

An air cleaner 7, a hot wire air flow meter 33, an intake air temperature sensor 34 (incorporated in the air flow meter 33), a throttle valve 5, and the like, are arranged in the intake passage 11 of the engine 1. The air cleaner 7 filters intake air. The throttle valve 5 adjust the intake air flow rate of the engine 1.

The throttle valve 5 is provided upstream (upstream in the flow of intake air) of the surge tank 11c, and is driven by a throttle motor 6. The opening degree of the throttle valve 5 is detected by a throttle opening degree sensor 35. The throttle opening degree of the throttle valve 5 is controlled by the ECU 200.

Specifically, the throttle opening degree of the throttle valve 5 is controlled such that an optimal intake air flow rate (target intake air flow rate) based on an operating state of the engine 1, such as an engine rotation speed Ne calculated from the signal output from the crank position sensor 31 and an accelerator pedal depression amount (accelerator operation amount) of a driver, is obtained. More specifically, an actual throttle opening degree of the throttle valve 5 is detected by the throttle opening degree sensor 35, and the throttle motor 6 of the throttle valve 5 is subjected to feedback control such that the actual throttle opening degree coincides with a throttle opening degree by which the target intake air flow rate is obtained (target throttle opening degree). Such a control system of the throttle valve 5 is called “electronic throttle system”, and is able to control the throttle opening degree independent of driver' accelerator pedal operation. For example, it is possible to execute intake air flow rate increasing control at the time of an engine start (described later).

A three-way catalyst 8 is arranged in the exhaust passage 12 of the engine 1. In the three-way catalyst 8, CO and HC in exhaust gas emitted from the combustion chambers 1d to the exhaust passage 12 are oxidized, NOx in the exhaust gas is reduced, and those are converted to harmless CO₂, H₂O and N₂. By so doing, exhaust gas is purified.

A front air-fuel ratio sensor 37 is arranged in the exhaust passage 12 at a portion upstream (upstream in the flow of exhaust gas) of the three-way catalyst 8. The front air-fuel ratio sensor 37 is a sensor that exhibits a linear characteristic for an air-fuel ratio. In addition, a rear O₂ sensor 38 is arranged in the exhaust passage 12 at a portion downstream of the three-way catalyst 8. The rear O₂ sensor 38 generates electromotive force in response to an oxygen concentration in exhaust gas. It is determined to be rich when the output from the rear O₂ sensor 38 is higher than a voltage (comparative voltage) corresponding to a stoichiometric air-fuel ratio; whereas it is determined to be lean when the output from the rear O₂ sensor 38 is lower than the comparative voltage. Signals output from these front air-fuel ratio sensor 37 and rear O₂ sensor 38 are used in air-fuel ratio feedback control (for example, see the technique described in Japanese Patent Application Publication No. 2010-007561 (JP 2010-007561 A)).

An intake valve 13 is provided between the intake passage 11 and each combustion chamber 1d. The intake passage 11 is communicated with or interrupted from each combustion chamber 1d by opening or closing a corresponding one of the intake valves 13. In addition, an exhaust valve 14 is provided between the exhaust passage 12 and each combustion chamber 1d. The exhaust passage 12 is communicated with or interrupted from each combustion chamber 1d by opening or closing a corresponding one of the exhaust valves 14. These intake valves 13 and exhaust valves 14 are respectively opened or closed by the rotation of an intake camshaft 21 and the rotation of an exhaust camshaft 22 to which the rotation of the crankshaft 15 is transmitted via a timing chain, and the like.

A cam position sensor 39 is provided near the intake camshaft 21. The cam position sensor 39 generates a pulse-shaped signal when the piston 1c of a specified cylinder (for example, first cylinder) reaches a compression top dead center (TDC). The cam position sensor 39 is, for example, an electromagnetic pickup, and is arranged so as to face one tooth (not shown) of the outer periphery of a rotor provided integrally with the intake camshaft 21. The cam position sensor 39 outputs a pulse-shaped signal (voltage pulse) when the intake camshaft 21 rotates. Note that the intake camshaft 21 (and the exhaust camshaft 22) rotates at half the rotation speed of the crankshaft 15, so the cam position sensor 39 generates one pulse-shaped signal for two revolutions (720° rotation) of the crankshaft 15.

Then, an injector (fuel injection valve) 2 that is able to inject fuel is arranged in each intake port 11a of the intake passage 11. The injector 2 is provided cylinder by cylinder. These injectors 2 are connected to a common delivery pipe 101. Fuel stored in a fuel tank 104 of a fuel supply system 100 (described later) is supplied to the delivery pipe 101. By so doing, fuel is injected from each injector 2 into the corresponding intake port 11a. The injected fuel is mixed with intake air to form an air-fuel mixture, and the air-fuel mixture is introduced into each combustion chamber 1d of the engine 1. The air-fuel mixture (fuel and air) introduced into each combustion chamber 1d is ignited by the ignition plug 3 to combust and explode. The corresponding piston 1c is reciprocated by high-temperature high-pressure combustion gas generated at this time, and the crankshaft 15 is rotated. Thus, the driving force (output torque) of the engine 1 is obtained. Combustion gas is emitted to the exhaust passage 12 as the corresponding exhaust valve 14 opens.

On the other hand, the fuel supply system 100 includes the delivery pipe 101, a fuel supply pipe 102, a fuel pump (for example, electric pump) 103, the fuel tank 104, and the like. The delivery pipe 101 is connected in common to the injectors 2 of the respective cylinders. The fuel supply pipe 102 is connected to the delivery pipe 101. The fuel supply system 100 is able to supply fuel stored in the fuel tank 104 to the delivery pipe 101 via the fuel supply pipe 102 by driving the fuel pump 103. Then, fuel is supplied to the injectors 2 of the respective cylinders by the thus configured fuel supply system 100.

In the thus configured fuel supply system 100, the fuel pump 103 is controlled by the ECU 200.

### ECU

As shown in FIG. 2, the ECU 200 includes a central processing unit (CPU) 201, a read only memory (ROM) 202, a random access memory (RAM) 203, a backup RAM 204, and the like.

The ROM 202 stores various control programs and maps, and the like, consulted at the time when those various control programs are executed. The CPU 201 executes various arithmetic processings on the basis of the various control programs and maps stored in the ROM 202. In addition, the RAM 203 is a memory that temporarily stores results computed in the CPU 201 and data, and the like, input from sensors. The backup RAM 204 is a nonvolatile memory that stores data, and the like, to be saved, for example, when the engine 1 is stopped.

The above CPU 201, ROM 202, RAM 203 and backup RAM 204 are connected to one another via a bus 207, and are connected to an input interface 205 and an output interface 206.

Various sensors, such as the crank position sensor 31, the coolant temperature sensor 32, the air flow meter 33, the intake air temperature sensor 34, the throttle opening degree sensor 35, an accelerator operation amount sensor 36, the front air-fuel ratio sensor 37, the rear O₂ sensor 38, the cam position sensor 39 and the shift position sensor 41, are connected to the input interface 205. The accelerator operation amount sensor 36 outputs a detected signal based on a depression amount of the accelerator pedal. The shift position sensor 41 detects the shift operating position of the shift lever 50. In addition, an ignition switch 40 is connected to the input interface 205. When the ignition switch 40 is turned on, the starter 10 starts cranking the engine 1.

The injectors 2, the igniters 4 of the ignition plugs 3, the throttle motor 6 of the throttle valve 5, the starter 10, the fuel pump 103 of the fuel supply system 100, and the like, are connected to the output interface 206.

Then, the ECU 200 executes various controls over the engine 1 on the basis of the detected signals from the above-described various sensors. The various controls over the engine 1 include drive control over the injectors 2 (fuel injection amount adjusting control), ignition timing control over the ignition plugs 3, drive control over the throttle motor 6 of the throttle valve 5 (intake air flow rate control), air-fuel ratio feedback control, and the like. Furthermore, the ECU 200 executes the following “engine starting control”.

A starting control device for an internal combustion engine according to the invention is implemented by a program executed by the above-described ECU 200.

### Engine Starting Control

First, in the engine 1 that includes the injectors 2, as described above, a fuel oil leakage, that is, a leakage of fuel from the injectors 2, may occur during an engine stop (during soaking). A fuel oil leakage from the injectors 2 varies depending on an operating condition and an environmental condition at the time when the engine is stopped last time. For example, when the fuel temperature and the fuel pressure are high at the time of an engine stop in a low-speed high-load driving state or an uphill travelling state or when an outside air temperature is high in summer, or the like, and the fuel temperature and the fuel pressure are high, a fuel oil leakage from the injectors 2 increases. As a fuel oil leakage from the injectors 2 increases, the concentration of HC in the intake manifold 11b (intake ports 11a) increases. Then, when the air-fuel ratio of air-fuel mixture becomes rich and exceeds the range of combustible air-fuel ratio due to the high HC concentration, a combustion state may deteriorate, causing a failure to start the engine 1.

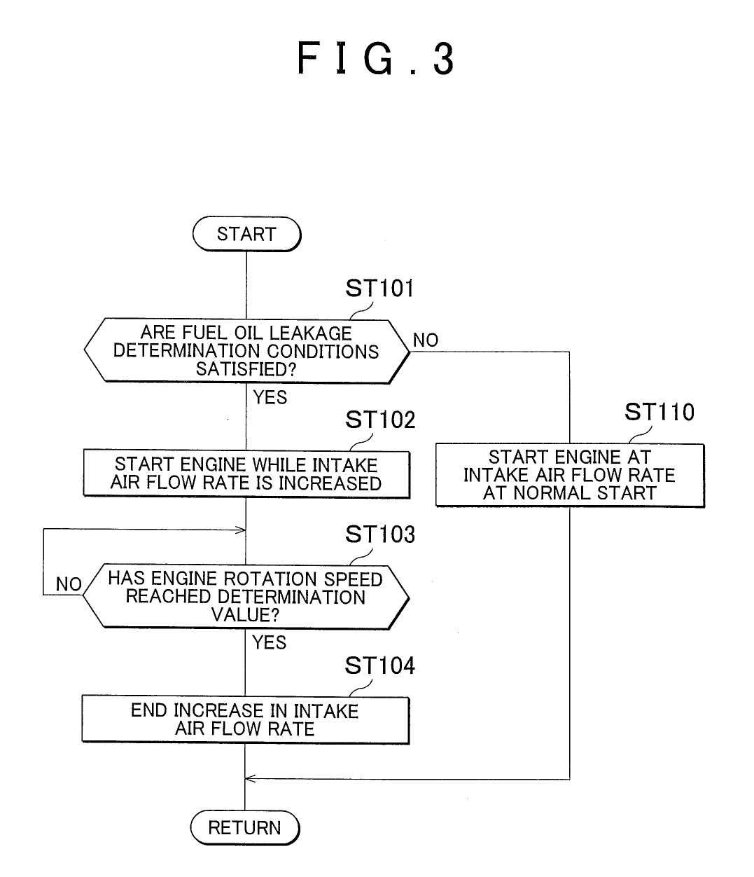

Then, in the present embodiment, in consideration of such a fuel oil leakage from the injectors 2 during an engine stop, the air-fuel ratio of air-fuel mixture is optimized by increasing the intake air flow rate at the time of an engine start. An example of the control (engine starting control) will be described with reference to the flowchart of FIG. 3. The control routine shown in FIG. 3 is executed by the ECU 200.

In this embodiment, the ECU 200 recognizes a coolant temperature and an intake air temperature at the time of an engine stop on the basis of the signal output from the coolant temperature sensor 32 and the signal output from the intake air temperature sensor 34 each time the engine 1 is stopped, and sequentially stores and updates the coolant temperature and the intake air temperature at the time of an engine stop in the RAM 203, and the like.

The control routine shown in FIG. 3 is started at the time when the ignition switch 40 is turned on (IG-ON). When the processing routine starts, first, in step ST101, a coolant temperature and an intake air temperature at the time of an engine start (at the time of an engine restart) are recognized from the signal output from the coolant temperature sensor 32 and the signal output from the intake air temperature sensor 34, and it is determined whether fuel oil leakage determination conditions for determining a fuel oil leakage from the injectors 2 are satisfied on the basis of those coolant temperature and intake air temperature at the time of the engine restart and the coolant temperature and the intake air temperature at the time of a stop of the engine 1 last time.

Specifically, it is determined whether all the following conditions J1, J2 and J3 are satisfied.
Condition J1: The coolant temperature at the time of a last engine stop is higher than or equal to a predetermined coolant temperature determination value and the intake air temperature at the time of the last engine stop is higher than or equal to a predetermined intake air temperature determination value.
Condition J2: The coolant temperature at an engine restart is lower than or equal to the predetermined coolant temperature determination value and the intake air temperature at the engine restart is lower than or equal to the predetermined intake air temperature determination value.
Condition J3: A decrease in the coolant temperature at the engine restart with respect to the coolant temperature at the last engine stop ([Coolant temperature at the time of the last stop]−[Coolant temperature at the time of the restart]) is larger than or equal to a coolant temperature decrease determination value set for each coolant temperature at the time of a last stop.
   The conditions J1 to J3 will be described.

### Condition J1

When the coolant temperature and the intake air temperature at the time when the engine 1 stops are high, a fuel oil leakage from the injectors 2 during an engine stop increases. In consideration of this point, the condition that the coolant temperature at the time of a last engine stop is higher than or equal to the predetermined coolant temperature determination value and the intake air temperature at the time of the last engine stop is higher than or equal to the predetermined intake air temperature determination value is set as one of the fuel oil leakage determination conditions.

Note that, for the coolant temperature determination value at an engine stop, a relationship between a coolant temperature at an engine stop and a fuel oil leakage amount at which the startability of the engine 1 may deteriorate is acquired through an experiment, simulation, or the like, in advance, and a coolant temperature at which the startability may deteriorate (engine-stop coolant temperature) is obtained on the basis of the relationship. Then, a value (coolant temperature determination value) adapted on the basis of the result is set. In addition, for the intake air temperature determination value at the time of an engine stop, a value adapted through similar process is set.

Here, the reason why two parameters, that is, the coolant temperature at the time of a last engine stop and the intake air temperature at the time of the last engine stop, are used in the condition J1 will be described.

For example, after an engine start, when the engine 1 is stopped before the coolant temperature reaches a warm-up temperature (temperature at which it is regarded that warm-up of the engine 1 is complete, and, for example, about 80° C.), the coolant temperature may be lower than the intake air temperature. Therefore, if determination is made on the basis of only the coolant temperature, the determination does not reflect an actual temperature of the injectors 2. In addition, the intake air temperature may be lower than the coolant temperature depending on the operating state of the engine 1, so, if determination is made on the basis of only the intake air temperature (the temperature of intake air near the air cleaner 7), accurate determination may not be made. In consideration of the above points, in this embodiment, the condition J1 is set using both the coolant temperature and the intake air temperature as parameters.

### Condition J2

In consideration of the fact that a fuel oil leakage from the injectors 2 increases as an engine stop time (soaking time) after a last engine stop to a restart extends, the condition that the coolant temperature at the time of an engine restart is lower than or equal to the predetermined coolant temperature determination value and the intake air temperature at the time of the engine restart is lower than or equal to the predetermined intake air temperature determination value is set as one of fuel oil leakage determination conditions. That is, when the coolant temperature and the intake air temperature at the time of an engine stop are respectively higher than or equal to the above-described determination values, as the engine stop time (soaking time) extends, the coolant temperature and the intake air temperature at the time of a restart decrease accordingly. By utilizing this fact, the condition that those coolant temperature and intake air temperature are respectively lower than or equal to the determination values is set as one of the fuel oil leakage determination conditions.

Note that, for the coolant temperature determination value and the intake air temperature determination value at the time of an engine restart, a value adapted through an experiment, calculation, or the like, is set in consideration of the relationship between a soaking time and a fuel oil leakage amount, or the like. In addition, in the condition J2 as well, due to a similar reason to the above-described condition J1, the condition J2 is set using the coolant temperature and the intake air temperature as parameters.

### Condition J3

When the coolant temperature at the time of an engine stop is, for example, higher than or equal to 90° C. and the oil temperature is higher than or equal to 90° C., the coolant temperature tends to be hard to decrease due to the influence of the temperature of lubricating oil (oil temperature), or the like. In consideration of this point, for the coolant temperature, in addition to the above condition J2, the condition that a decrease in the coolant temperature at the time of an engine restart with respect to the coolant temperature at the time of a last engine stop ([Coolant temperature at the time of a last engine stop]−[Coolant temperature at the time of a restart]) is larger than or equal to a coolant temperature decrease determination value set for each engine-stop coolant temperature is used. The coolant temperature decrease determination value used in the condition J3 is obtained by consulting a map (table) shown in FIG. 5 on the basis of the coolant temperature at the time of an engine stop.

The map shown in FIG. 5 is created by mapping values (coolant temperature decrease determination values) adapted through an experiment, calculation, or the like, in consideration of the influence of the above-described oil temperature, and is stored in the ROM 202 of the ECU 200. In the map shown in FIG. 5, the coolant temperature decrease determination value is set to be lower when the coolant temperature is higher than or equal to 90° C. than when the coolant temperature is lower than 90° C.

Note that, in the map shown in FIG. 5, the coolant temperature decrease determination value between 80° C. and 90° C. is set to a constant value (10° C.). In addition, the coolant temperature decrease determination value between 90° C. and 105° C. is obtained through interpolation calculation.

Here, another determination condition may be set as the fuel oil leakage determination condition as long as it is possible to determine combustion deterioration (engine start failure) at the time of a restart due to a fuel oil leakage from the injectors 2 during an engine stop. For example, the condition that a difference between the coolant temperature at the time of a last engine stop and the coolant temperature at the time of an engine restart is larger than or equal to a predetermined value and the intake air temperature at the time of the restart is lower than or equal to a predetermined value may be employed. In addition, a condition that sets the above-described condition J3 in addition to the above condition may be employed.

Referring back to the flowchart of FIG. 3, when negative determination is made in step ST101 (NO), that is, when the fuel oil leakage determination conditions are not satisfied, the process proceeds to step ST110. In step ST110, the engine 1 is started at an intake air flow rate at the time of a normal start. Note that the intake air flow rate at the time of a normal start is, for example, an intake air flow rate calculated from a map for a normal start on the basis of the conditions (coolant temperature, intake air temperature, corrected value so far, and the like) at the time of an engine start.

On the other hand, when affirmative determination is made in step ST101 (YES), that is, when the fuel oil leakage determination conditions are satisfied, the process proceeds to step ST102.

In step ST102, the opening degree of the throttle valve 5 (throttle opening degree) is set so as to be larger than that at the time of a normal start, the intake air flow rate is increased as compared with at the time of a normal start, and then the engine 1 is started (scavenging control is executed at the time of an engine start). The throttle opening degree at this time, that is, the throttle opening degree of the throttle valve 5 at the time when control for increasing the intake air flow rate (scavenging control) is executed is set such that negative pressure is not generated in the intake passage 11. The throttle opening degree at which negative pressure is not generated in the intake passage 11 is a value (throttle opening degree) adapted through an experiment, calculation, or the like, using, for example, a cranking rotation speed at the time of an engine start as a parameter. The throttle opening degree for intake air increasing control may be a constant value or may be set variably on the basis of a cranking rotation sped, or the like, as will be described later.

Note that the throttle opening degree at which negative pressure is not generated in the intake passage 11 is a throttle opening degree in a range in which, when the throttle valve 5 is opened at a degree larger at the time of an engine start than at the time of a normal start, intake pipe negative pressure (intake manifold negative pressure) is not generated, and is, for example, an opening degree that is obtained by adding a margin (open-side value) to a lower limit opening degree of the throttle opening degree opening range in which the intake manifold negative pressure is not generated. The throttle opening degree is set such that, within the range in which intake pipe negative pressure (intake manifold negative pressure) is not generated, the amount of fresh air is maximum (scavenging effect is maximum).

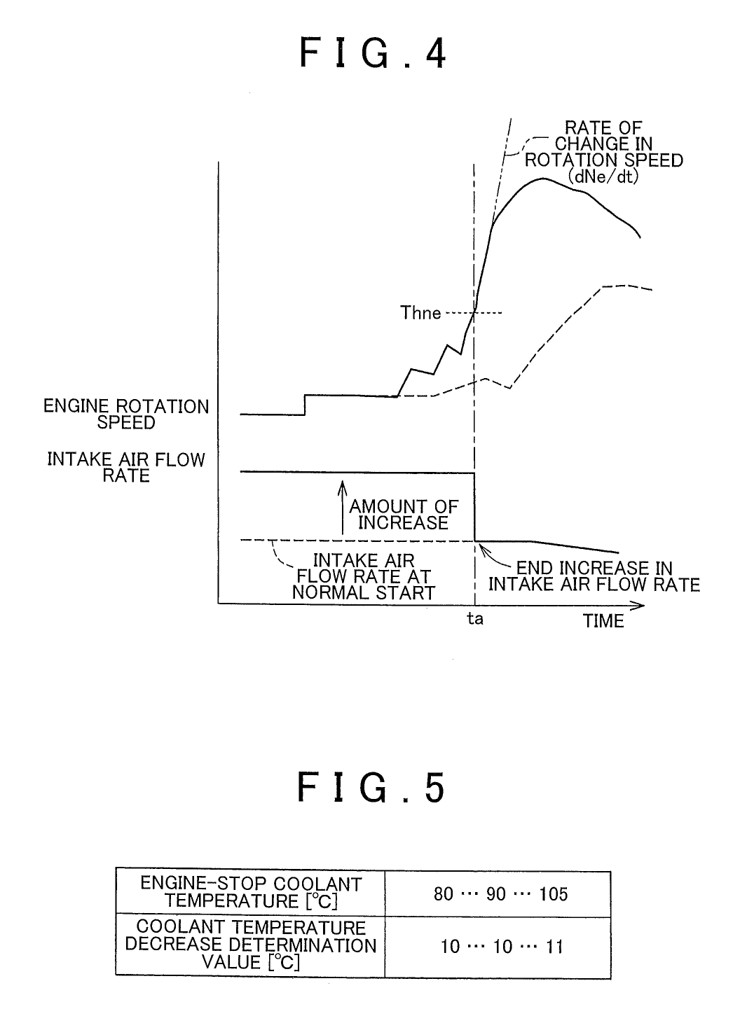

Subsequently, in step ST103, it is determined whether the engine rotation speed Ne calculated from the signal output from the crank position sensor 31 has reached a predetermined determination value Thne (see FIG. 4). When negative determination is made (NO), the process waits until the engine rotation speed Ne at the time of a start reaches the determination value Thne. Then, at the time when affirmative determination is made in step ST103 (YES), that is, at the time when the engine rotation speed Ne at the time of a start has reached the determination value Thne, the process proceeds to step ST104.

Note that, for the determination value Thne used in determination of step ST103, the engine rotation speed at which it is possible to sufficiently scavenge an air-fuel mixture having a high concentration of HC during cranking at the time of an engine start is acquired through an experiment, calculation, or the like, in advance and then a value (for example, 1000 rpm) adapted on the basis of the result is set.

Then, in step ST104, intake air flow rate increasing control is ended, and the throttle valve 5 is set into normal control to return the intake air flow rate to an original value (returned to normal control, see FIG. 4). After that, the control routine once ends.

As described above, according to the present embodiment, when a fuel oil leakage from the injectors 2 during an engine stop is large and the fuel oil leakage determination conditions are satisfied, the intake air flow rate is increased and then the engine 1 is started, so it is possible to early scavenge an air-fuel mixture having a high concentration of HC while the starter 10 is cranking the engine 1. By so doing, it is possible to optimize the air-fuel ratio at the time of an engine start (set the air-fuel ratio to an appropriate value within a combustible range), so, as shown in FIG. 4, a combustion state gets better and the engine rotation speed quickly increases. As a result, a torque at the time of an engine start increases, and the startability of the engine 1 improves.

Here, in the present embodiment, when the fuel oil leakage determination conditions are satisfied, the intake air flow rate to be increased at the time of an engine start may be a constant amount or may be set variably, as described above.

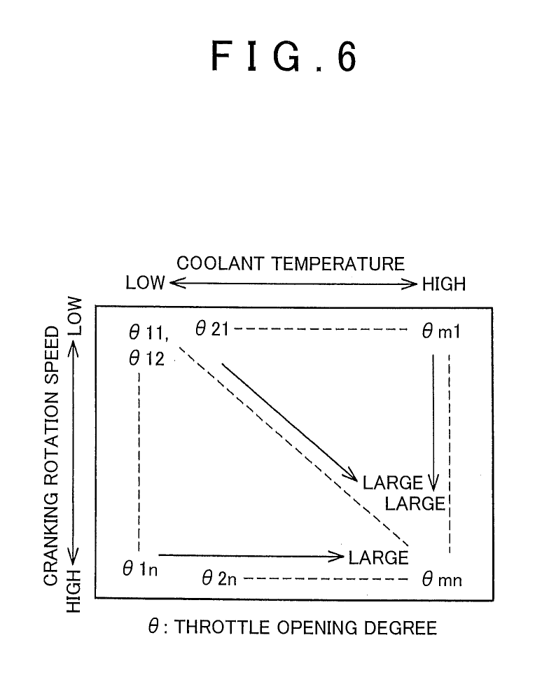

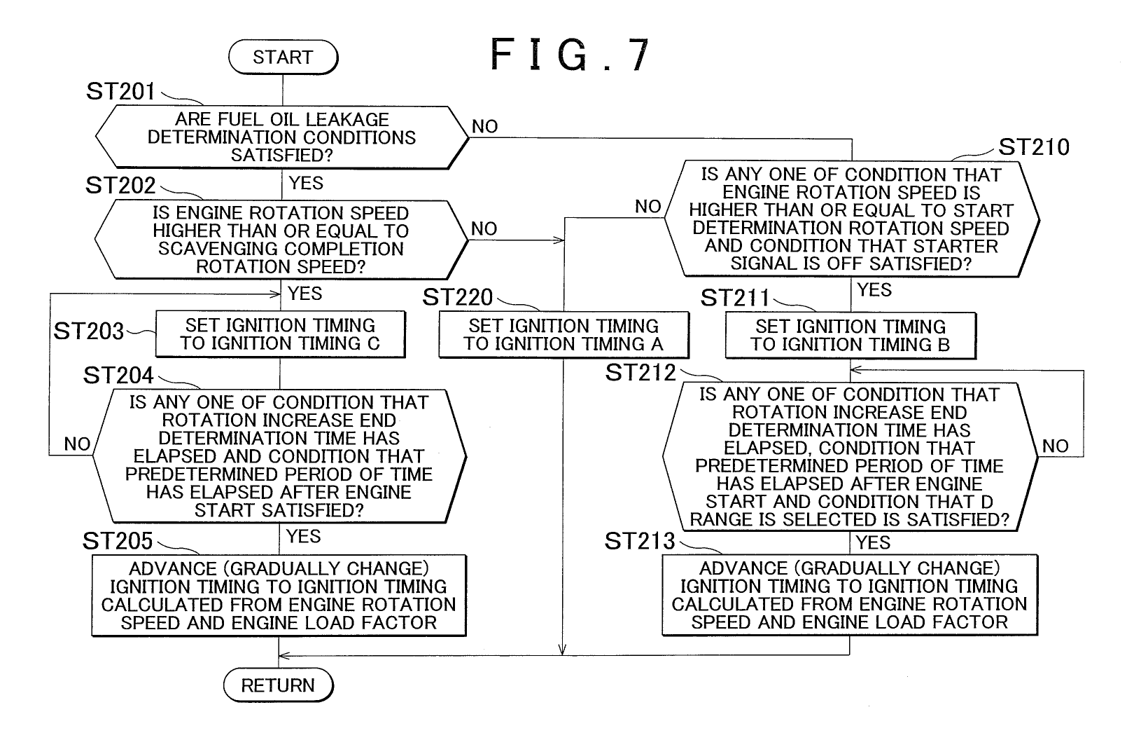

When the intake air flow rate to be increased at the time of an engine start is set variably, in consideration of the fact that negative pressure in the intake passage (intake manifold negative pressure) increases with an increase in cranking rotation speed at the time of an engine start, the opening degree of the throttle valve 5 is increased with an increase in cranking rotation speed at the time of an engine start to gradually increase (or increase in a stepwise manner) the intake air flow rate such that negative pressure is not generated in the intake passage 11. In this case, the throttle opening degree θ of the throttle valve 5 is set by consulting the map shown in FIG. 6 on the basis of the coolant temperature (coolant temperature at the time of an engine start) obtained from the signal output from the coolant temperature sensor 32 and the cranking rotation speed through the starter 10 (recognized from the signal output from the crank position sensor 31). By so doing, control for gradually increasing (or increasing in a stepwise manner) the intake air flow rate with an increase in cranking rotation speed just needs to be executed.

Note that the map shown in FIG. 6 is created by mapping values adapted from the throttle opening degree θ, at which negative pressure is not generated in the intake passage 11, through an experiment, calculation, or the like, using the coolant temperature and the cranking rotation speed as parameters, and is, for example, stored in the ROM 202 of the ECU 200. In the map shown in FIG. 6, the throttle opening degree θ is set so as to increase as the coolant temperature increases and as the cranking rotation speed increases.

### ALTERNATIVE EMBODIMENT OF ENGINE STARTING CONTROL

Next, an alternative embodiment of engine starting control executed by the ECU 200 will be described with reference to the flowchart shown in FIG. 7.

In this embodiment, the ECU 200 recognizes a coolant temperature and an intake air temperature at the time of an engine stop on the basis of the signal output from the coolant temperature sensor 32 and the signal output from the intake air temperature sensor 34 each time the engine 1 is stopped, and sequentially stores and updates the coolant temperature and the intake air temperature at the time of an engine stop in the RAM 203, and the like.

The control routine shown in FIG. 7 is started at the time when the ignition switch 40 is turned on (IG-ON). When the processing routine starts, first, in step ST201, it is determined whether the fuel oil leakage determination conditions are satisfied. The determination process of step ST201 is the same as the determination process of step ST101 shown in FIG. 3, so the detailed description is omitted here.

When negative determination is made in step ST201 (NO), the process proceeds to step ST210. When affirmative determination is made in step ST201 (YES), the process proceeds to step ST202.

In step ST202, it is determined whether the engine rotation speed Ne calculated from the signal output from the crank position sensor 31 increases to or above a scavenging completion rotation speed (the same value as the above-described scavenging completion determination value Thne, for example, 1000 rpm). When negative determination is made (NO) (when the engine rotation speed Ne does not increase to the scavenging completion rotation speed), the process proceeds to step ST220.

When affirmative determination is made in step ST202 (YES), it is determined that the engine rotation speed is quickly increased through scavenging control (intake air flow rate increasing control) at the time of an engine start, and the process proceeds to step ST203.

In step ST203, after scavenging control (intake air flow rate increasing control) at the time of an engine start has been completed, ignition retardation control is executed in order to prevent a steep increase in the engine rotation speed Ne. Specifically, an ignition timing C (for example, −10° BTDC (10° [CA] retarded with respect to BTDC)) is set, and ignition timing control (retardation control) over the ignition plugs 3 (igniters 4) is executed.

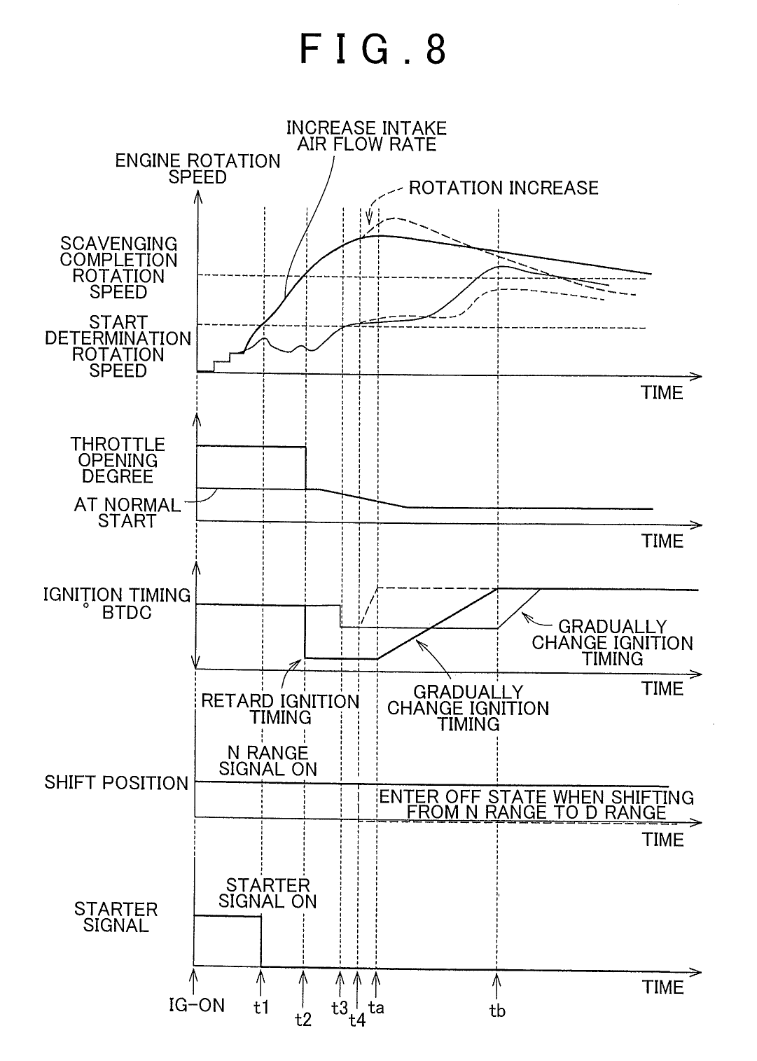

Subsequently, in step ST204, it is determined whether any one of the condition that “a rotation increase end determination time ta (see FIG. 8) has been reached” and the condition that “a predetermined period of time has elapsed after an engine start” is satisfied. When negative determination is made (NO), retardation control in step ST203 is continued. Note that the rotation increase end determination time ta is a period of time from engine start time t1 (or cranking start time) to an end of increase in the engine rotation speed Ne when intake air flow rate increasing control is executed at the time of an engine start, and is adapted through an experiment, calculation, or the like. In addition, the elapsed time after an engine start is, for example, a period of time until the engine rotation speed becomes stable after an engine start, and is adapted through an experiment, calculation, or the like.

Then, at the time when affirmative determination is made in step ST204 (YES), the process proceeds to step ST205. In step ST205, the ignition timing is calculated by consulting a map, which is adapted through an experiment, calculation, or the like, in advance, on the basis of a current engine rotation speed Ne and an engine load factor kl, calculated from the signal output from the crank position sensor 31, and gradually changing process for gradually advancing the ignition timing retarded in step ST203 is executed (see FIG. 8) to change an actual ignition timing to the above-described calculated ignition timing (normal control value). After that, the control routine once ends.

Note that the above load factor kl may be, for example, calculated by consulting a map, or the like, on the basis of the engine rotation speed Ne and the intake air pressure as a value that indicates a current load rate with respect to a maximum engine load.

On the other hand, when negative determination is made in step ST201 (NO), that is, when the fuel oil leakage determination conditions are not satisfied (in the case of a normal start), the process proceeds to step ST210. In step ST210, it is determined whether any one of the condition that “the engine rotation speed Ne calculated form the signal output from the crank position sensor 31 is higher than or equal to a start determination rotation speed (see FIG. 8, for example, 500 rpm)” and the condition that “a starter signal is off” is satisfied. When negative determination is made, the process proceeds to step ST220. In step ST220, after the ignition timing is set to an ignition timing A (for example, 5° BTDC), the control routine once ends.

When affirmative determination is made in step ST210 (YES), the process proceeds to step ST211. In step ST211, the ignition timing is set to an ignition timing B (for example, 2° BTDC), and ignition timing control (retardation control) over the ignition plugs 4 is executed.

Subsequently, in step ST212, it is determined whether any one of the condition that “a rotation increase end determination time tb (see FIG. 8) has been reached”, the condition that “a predetermined period of time has elapsed after an engine start” and the condition that “the shift range is changed into D range” is satisfied. When negative determination is made (NO), ignition timing control in step ST211 is continued.

Note that the rotation increase end determination time tb is a period of time from engine start time t3 (or cranking start time) to an end of increase in the engine rotation speed Ne when the engine is started at the intake air flow rate at the time of a normal start, and is adapted through an experiment, calculation, or the like. In addition, the predetermined period of time after an engine start is, for example, a period of time until the engine rotation speed becomes stable after an engine start, and is adapted through an experiment, calculation, or the like.

Then, at the time when affirmative determination is made in step ST212 (YES), the process proceeds to step ST213. In step ST213, the ignition timing is calculated by consulting a map, which is adapted through an experiment, calculation, or the like, in advance, on the basis of a current engine rotation speed Ne and an engine load factor kl, calculated from the signal output from the crank position sensor 31, and gradually changing process for gradually advancing the ignition timing is executed (see FIG. 8) to change an actual ignition timing to the above-described calculated ignition timing. After that, the control routine once ends.

Next, engine starting control in this embodiment will be specifically described with reference to the timing chart shown in FIG. 8.

First, description will be made on the case where the fuel oil leakage determination conditions are satisfied.

When the fuel oil leakage determination conditions are satisfied, first, the throttle opening degree at the time of a start of cranking at IG-ON is set so as to be larger than that in normal starting control, and the intake air flow rate is increased with respect to that in normal starting control. Through cranking with such an increased intake air flow rate, fuel (HC) leaked from the injectors 2 into the intake manifold 11b (intake ports 11a) is scavenged, so the air-fuel ratio of air-fuel mixture becomes an appropriate air-fuel ratio. By so doing, a combustion state gets better and the engine rotation speed quickly increases. In this increasing process, the engine rotation speed Ne exceeds the start determination rotation speed (for example, 500 rpm) (t1), and, after that, an increase in the intake air flow rate is ended (the throttle opening degree is returned to that in normal control) at the time t2 when the engine rotation speed Ne has reached the scavenging completion rotation speed (for example, 1000 rpm). Furthermore, ignition timing retardation control is executed by setting the ignition timing to −40° BTDC. Through such ignition timing retardation control, it is possible to suppress a steep increase in the engine rotation speed Ne after the engine rotation speed Ne has reached the scavenging completion rotation speed.

The ignition timing retardation control is continued until the above-described rotation increase end determination time ta has been reached. Then, at the time when the rotation increase end determination time ta has been reached, gradually changing process for gradually advancing the ignition timing retarded at the above time t2 is executed to change an actual ignition timing to a normal control value (ignition timing calculated on the basis of a current engine rotation speed Ne and a load factor kl) after an engine start.

Here, in control in this embodiment, while ignition timing retardation control is being continued, for example, even when the shift range is shifted from N range to D range through driver's operation of the shift lever 50 at the time t4, ignition timing retardation control is continued. By so doing, it is possible to suppress deterioration of drivability at the time of a change of shift range from N range and an increase in the rotation (increase in the rotation indicated by broken line in FIG. 8) of the engine 1.

Next, description will be made on the case where the fuel oil leakage determination conditions are not satisfied (normal starting control) will be described.

When the fuel oil leakage determination conditions are not satisfied, first, the throttle opening degree at the time of a start of cranking at IG-ON is set to an opening degree in normal starting control, and the engine is started at the intake air flow rate at the time of a normal start. After the start of cranking, the ignition timing is retarded at time t3 at which the engine rotation speed Ne has reached the start determination rotation speed (for example, 500 rpm). This state is continued until the above-described rotation increase end determination time tb has been reached. Then, at the time when the rotation increase end determination time tb has been reached, gradually changing process for gradually advancing the ignition timing is executed to change an actual ignition timing to an ignition timing in normal control (calculated on the basis of a current engine rotation speed Ne and a load factor kl) after an engine start.

Note that, at the time of a normal start, an increase in the engine rotation speed (an increase in torque) is smaller than that at the time of an increase in the intake air flow rate, so, for example, even when the shift range is shifted from N range to D range through driver's operation of the shift lever 50 at time t4 before the rotation increase end determination time tb has been reached, the influence on drivability at the time of a change of shift range from N range is small. Then, in this embodiment, gradually changing process for gradually advancing the ignition timing at time t4 at which shift operation is performed to change an actual ignition timing to an ignition timing in normal control after an engine start (see broken line in FIG. 8).

### ALTERNATIVE EMBODIMENTS

In the above-described embodiments, the timing at which intake air flow rate increasing control (scavenging control) is ended is set to the time at which the engine rotation speed has reached the determination value; however, the invention is not limited to this configuration. For example, it is applicable that, at the time when a rate of change dNe/dt (see alternate long and two short dashes line in FIG. 4) of the engine rotation speed at the time of an engine start has reached a predetermined determination value (for example, a rate of increase in the engine rotation speed at which it is possible to sufficiently scavenge an air-fuel mixture having a high concentration of HC), intake air flow rate increasing control (scavenging control) is ended. In addition, it is applicable that, at the time when the engine rotation speed becomes higher than or equal to a determination value and a rate of change in the engine rotation speed is higher than or equal to a predetermined value at the time of an engine start, intake air flow rate increasing control (scavenging control) is ended.

In addition, control for increasing the intake air flow rate at the time of an engine start may be ended when the number of revolutions of the engine 1 is larger than or equal to a predetermined value. In this case, it is applicable that a count value is counted up by one each time the engine 1 (crankshaft) rotates 360° and, when the count value is larger than or equal to a predetermined value (for example, a count value (the number of revolutions of the engine) at which it is possible to sufficiently scavenge an air-fuel mixture having a high concentration of HC), control for increasing the intake air flow rate is ended.

In the above-described embodiments, the invention is applied to starting control over the port-injection engine (internal combustion engine); however, the invention is not limited to this configuration. The invention is also applicable to starting control over a direct-injection engine.

In the above-described embodiments, the invention is applied to the four-cylinder engine; however, the invention is not limited to this configuration. The invention is also applicable to starting control over an engine having a selected number of cylinders, such as a six-cylinder engine. In addition, the invention is also applicable to not only starting control over an in-line multi-cylinder engine but also starting control over a multi-cylinder V-engine.

The invention is usable in a starting control device for an internal combustion engine (engine) mounted on a vehicle, or the like, and is, more particularly, usable in a starting control device for an internal combustion engine for purposes of ensuring appropriate startability.

What is claimed is:

1. A starting control device for an internal combustion engine that causes an air-fuel mixture of intake air and fuel injected from a fuel injection valve to combust in a combustion chamber to obtain power, comprising:
a control unit configured to execute scavenging control at the time of a start of the engine when a condition for determining a fuel oil leakage from the fuel injection valve is satisfied.

2. The starting control device according to claim 1, wherein the scavenging control is control for increasing an intake air flow rate at the time of a start of the engine.

3. The starting control device according to claim 2, wherein the control unit increases the intake air flow rate by controlling an opening degree of a throttle valve, provided in an intake passage that communicates with the combustion chamber, at the time of a start of the engine.

4. The starting control device according to claim 3, wherein the control unit controls the opening degree of the throttle valve in the case of increasing the intake air flow rate to an opening degree at which negative pressure is not generated in the intake passage downstream of the throttle valve in a flow of the intake air.

5. The starting control device according to claim 3, wherein the control unit sets the opening degree of the throttle valve in the case of increasing the intake air flow rate on the basis of an engine coolant temperature and an engine rotation speed.

6. The starting control device according to claim 3, wherein the control unit increases the opening degree of the throttle valve with an increase in cranking rotation speed at the time of a start of the engine.

7. The starting control device according to claim 2, wherein the control unit ends the control for increasing the intake air flow rate at the time of a start of the engine when an engine rotation speed becomes higher than or equal to a predetermined value or when a rate of increase in the engine rotation speed becomes higher than or equal to a predetermined value.

8. The starting control device according to claim 7, wherein, when the control unit ends the control for increasing the intake air flow rate at the time of a start of the engine, the control unit executes ignition timing retardation control when the rate of increase in the engine rotation speed is higher than or equal to the predetermined value.

9. The starting control device according to claim 2, wherein the control unit ends the control for increasing the intake air flow rate at the time of a start of the engine when an engine rotation speed becomes higher than or equal to a predetermined value and when a rate of increase in the engine rotation speed becomes higher than or equal to a predetermined value.

10. The starting control device according to claim 9, wherein, when the control unit ends the control for increasing the intake air flow rate at the time of a start of the engine, the control unit executes ignition timing retardation control when the rate of increase in the engine rotation speed is higher than or equal to the predetermined value.

11. The starting control device according to claim 2, wherein the control unit ends the control for increasing the intake air flow rate at the time of a start of the engine when the number of revolutions of the internal combustion engine is larger than or equal to a predetermined value.

12. The starting control device according to claim 11, wherein, when the control unit ends the control for increasing the intake air flow rate at the time of a start of the engine, the control unit executes ignition timing retardation control when a rate of increase in the engine rotation speed is higher than or equal to the predetermined value.

13. A starting control method for an internal combustion engine that causes an air-fuel mixture of intake air and fuel injected from a fuel injection valve to combust in a combustion chamber to obtain power, comprising:
executing scavenging control at the time of a start of the engine when a condition for determining a fuel oil leakage from the fuel injection valve is satisfied.

14. The starting control method according to claim 13, wherein the scavenging control is control for increasing an intake air flow rate at the time of a start of the engine.

15. The starting control method according to claim 14, wherein the intake air flow rate is increased by controlling an opening degree of a throttle valve, provided in an intake passage that communicates with the combustion chamber, at the time of a start of the engine.

16. The starting control method according to claim 15, wherein the opening degree of the throttle valve in the case of increasing the intake air flow rate is controlled to an opening degree at which negative pressure is not generated in the intake passage downstream of the throttle valve in a flow of the intake air.

17. The starting control method according to claim 15, wherein the opening degree of the throttle valve in the case of increasing the intake air flow rate is set on the basis of an engine coolant temperature and an engine rotation speed.

18. The starting control method according to claim 15, wherein the opening degree of the throttle valve is increased with an increase in cranking rotation speed at the time of a start of the engine.

19. The starting control method according to claim 14, wherein the control for increasing the intake air flow rate at the time of a start of the engine is ended when an engine rotation speed becomes higher than or equal to a predetermined value or when a rate of increase in the engine rotation speed becomes higher than or equal to a predetermined value.

20. The starting control method according to claim 19, wherein, when the control for increasing the intake air flow rate at the time of a start of the engine is ended, ignition timing retardation control is executed when the rate of increase in the engine rotation speed is higher than or equal to the predetermined value.

21. The starting control method according to claim 14, wherein the control for increasing the intake air flow rate at the time of a start of the engine is ended when an engine rotation speed becomes higher than or equal to a predetermined value or when a rate of increase in the engine rotation speed becomes higher than or equal to a predetermined value.

22. The starting control method according to claim 21, wherein, when the control for increasing the intake air flow rate at the time of a start of the engine is ended, ignition timing retardation control is executed when the rate of increase in the engine rotation speed is higher than or equal to the predetermined value.

23. The starting control method according to claim 14, wherein the control for increasing the intake air flow rate at the time of a start of the engine is ended when the number of revolutions of the internal combustion engine is larger than or equal to a predetermined value.

24. The starting control method according to claim 23, wherein, when the control for increasing the intake air flow rate at the time of a start of the engine is ended, ignition timing retardation control is executed when a rate of increase in the engine rotation speed is higher than or equal to the predetermined value.
